(19) United States
(12) Patent Application Publication
(10) Pub. No.: US 2015/0312945 A1
(43) Pub. Date: Oct. 29, 2015

(54) APPARATUS AND METHOD FOR MANAGING INSTANT CONNECTION BASED ON WIRELESS LOCAL AREA NETWORK

(71) Applicant: ELECTRONICS AND TELECOMMUNICATIONS RESEARCH INSTITUTE, Daejeon (KR)

(72) Inventors: Choong Bum PARK, Daejeon (KR); Jae Guk GWON, Daejeon (KR); Do Hyung KIM, Daejeon (KR); Cheol RYU, Daejeon (KR); Jin Suk MA, Daejeon (KR); Jae Bok PARK, Daejeon (KR); Seok Jin YOON, Daejeon (KR); Kyung Hee LEE, Daejeon (KR); Jae Ho LEE, Daejeon (KR); Hyung Seok LEE, Daejeon (KR); Sung Ho IM, Daejeon (KR)

(21) Appl. No.: 14/492,317

(22) Filed: Sep. 22, 2014

(30) Foreign Application Priority Data
Apr. 29, 2014 (KR) 10-2014-0051722

(51) Int. Cl. H04W 76/02; H04W 12/04

(52) U.S. Cl. CPC H04W 76/02; H04W 12/04; H04W 84/12

(57) ABSTRACT

An apparatus and a method for managing instant connection based on a wireless local area network are provided. The method includes: creating, by an accessed terminal, connection information required for setting connection therewith; creating, by the accessed terminal, a management frame by using the connection information; transmitting, by the accessed terminal, the created management frame to a peripheral terminal; receiving, by the peripheral terminal, the management frame and extracting connection information from the received management frame; and setting, by the peripheral terminal, connection with the accessed terminal by accessing the accessed terminal by using the extracted connection information to rapidly access a desired terminal without performing a device discovery process.

### CROSS-REFERENCE TO RELATED APPLICATIONS

This application claims priority to and the benefit of Korean Patent Application No. 10-2014-0051722 filed in the Korean Intellectual Property Office on Apr. 29, 2014, the entire contents of which are incorporated herein by reference.

### BACKGROUND OF THE INVENTION

1. Technical Field

The present invention relates to an apparatus and a method for managing instant connection based on a wireless local area network that enable rapid access to a desired peripheral device without searching for peripheral devices at the time of accessing the wireless local area network.

2. Description of the Related Art

In general, wireless fidelity (Wi-Fi) uses an IEEE 802.11 standard which is a wireless LAN standard established in the Institute of Electrical and Electronics Engineers (IEEE).

The Wi-Fi is divided into an infrastructure mode in which a wireless access point (AP) such as a wireless router sends and receives data to and from a plurality of terminals positioned within a predetermined radius and an ad hoc mode in which the terminals send and receive data in a peer to peer (P2P) form without a wireless access point (AP) according to a device type or a use mode.

The infrastructure mode is a general Wi-Fi (legacy Wi-Fi) use form in which the terminal accesses a wireless local area network or a wired communication network through the wireless AP to perform communication with other terminals which exist on the communication network. On the contrary, the ad hoc mode as a form in which the terminals communicate with each other through direct connection without assistance from the wireless access point is named as Wi-Fi P2P or Wi-Fi Direct. The wireless communication function is performed by WPA_Supplicant which is Wi-Fi management service Demon software in the terminal. In recent years, the Demon software supports a concurrent operation in which Wi-Fi communication and Wi-Fi P2P communication can be concurrently used by using one Wi-Fi module.

Since the terminal in the related art should find a media access control (MAC) address or an Internet protocol (IP) address of a remote terminal in order to access the remote terminal, a device discovery process should be performed before the access.

Since the terminal should obtain a service set identifier (SSID) of the wireless access point, a Wi-Fi protected setup (WPS) scheme which is a security scheme used by the wireless access point, and a password in advance for general Wi-Fi connection, the wireless access point discovery process should be performed before the access to the wireless access point.

As described above, the terminal should previously perform the device discovery before performing Wi-Fi connection or Wi-Fi P2P connection and a user selects any one device among discovered devices to input the password as necessary. Accordingly, since 10 seconds or more are required for the Wi-Fi connection or Wi-Fi P2P connection in the related art, a moving terminal cannot be rapidly connected to other terminals or wireless access points that exist therearound.

### SUMMARY OF THE INVENTION

The present invention has been made in an effort to provide an apparatus and a method for managing instant connection based on a wireless local area network, which invite the access of peripheral terminals by transferring connection information required for accessing the wireless local area network such as Wi-Fi and Wi-Fi P2P to the peripheral terminals through a management frame.

The present invention has also been made in an effort to provide an apparatus and a method for managing instant connection based on a wireless local area network, which extract connection information from a management frame by receiving a management frame transmitted from peripheral terminals and directly access a corresponding terminal by using the extracted connection information.

An exemplary embodiment of the present invention provides a method for managing instant connection based on a wireless local area network, including: creating, by an accessed terminal, connection information required for setting connection therewith; creating, by the accessed terminal, a management frame by using the connection information; transmitting, by the accessed terminal, the created management frame to a peripheral terminal; receiving, by the peripheral terminal, the management frame and extracting connection information from the received management frame; and setting, by the peripheral terminal, connection with the accessed terminal by accessing the accessed terminal by using the extracted connection information.

The accessed terminal may be a wireless access point or a mobile terminal.

The connection information may be Wi-Fi connection information constituted by a service set identifier (SSID), a security scheme, and a password of the wireless access point.

The connection information may be Wi-Fi P2P connection information constituted by a media access control (MAC) address, a security scheme, and a personal identification number of the terminal.

The security scheme may be any one of WPS (Wi-Fi Protected Setup), WPA-PSK (Wi-Fi Protected Access-Pre-Shared Key), and WPA2-PSK (Wi-Fi Protected Access II-Pre-Shared Key).

In the setting of connection, Wi-Fi connection or Wi-Fi peer to peer (P2P) connection may be formed by using the extracted connection information.

Another exemplary embodiment of the present invention provides an apparatus for managing instant connection based on a wireless local area network, the apparatus including: a wireless communication unit performing wireless communication on the wireless local area network; a connection information creating unit creating connection information for accessing another terminal positioned on the wireless local area network; a management frame creating unit creating a management frame by using the connection information received from the connection information creating unit; a connection information extracting unit extracting the connection information from the received management frame by parsing the management frame received through the wireless communication unit; and a control unit transmitting the management frame created by the management frame creating unit to a peripheral terminal through the wireless communication unit and performing connection setting by accessing the corresponding terminal by using the connection information extracted by the connection information extracting unit.

The apparatus may further include a user input unit receiving a password and a personal identification number from a user, and the connection information creating unit may create the connection information by using the password and the personal identification number.

The control unit may visualize and display effective connection information based on the connection information extracted by the connection information extracting unit.

When any one connection information in the displayed effective connection information is selected, the control unit may set Wi-Fi connection or Wi-Fi peer to peer (P2P) connection with the corresponding terminal by using the selected connection information.

The control unit may set the Wi-Fi connection or the Wi-Fi P2P connection by accessing a terminal having largest signal intensity among terminals corresponding to the effective connection information.

According to exemplary embodiments of the present invention, since connection information required for accessing a wireless local area network such as Wi-Fi or Wi-Fi P2P is transferred to peripheral terminals through a management frame, the peripheral terminal can ensure connection information of an accessed terminal in advance. Therefore, the present invention can directly access the corresponding device by skipping a device discovery process and using the pre-ensured connection information.

Connection information can be extracted from a management frame by receiving a management frame transmitted from peripheral terminals and a corresponding terminal can be directly accessed by using the extracted connection information. Accordingly, a time required for Wi-Fi connection or Wi-Fi P2P connection can be decreased and a process in which a user inputs a password or a personal identification number can also be skipped, and as a result, user convenience is improved.

Objects of the present invention are not limited the aforementioned object and other objects and advantages of the present invention, which are not mentioned can be appreciated by the following description and will be more apparently know by the exemplary embodiments of the present invention. It can be easily known that the objects and advantages of the present invention can be implemented by the means and a combination thereof described in the appended claims.

### BRIEF DESCRIPTION OF THE DRAWINGS

FIG. 1 illustrates a structure of a wireless local area network according to an exemplary embodiment of the present invention.

FIG. 2 is a block configuration diagram of an apparatus for managing instant connection based on a wireless local area network according to an exemplary embodiment of the present invention.

FIG. 3 is a flowchart illustrating a method for managing instant connection based on a wireless local area network according to an exemplary embodiment of the present invention.

FIG. 4 is an exemplary diagram illustrating a display screen of a current accessible device list of a terminal according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. It should be noted that in the following description, only a part required to understand an operation according to the exemplary embodiment of the present invention will be described and a description of other parts will be skipped not to obscure the spirit of the present invention.

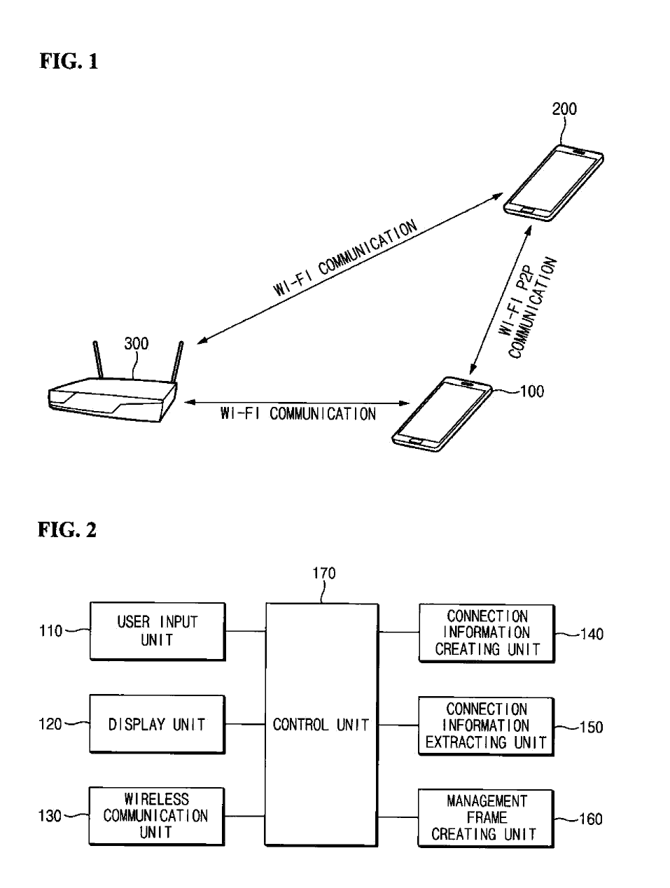

FIG. 1 illustrates a structure of a wireless local area network according to an exemplary embodiment of the present invention.

As illustrated in FIG. 1, the wireless local area network is configured to include first and second terminals 100 and 200 and a wireless access point (AP) 300. In the wireless local area network, Wi-Fi and/or Wi-Fi peer to peer (P2P) connections coexist.

The first terminal 100 and the second terminal 200 may perform a concurrent operation through Wi-Fi communication in which the first terminal 100 and the second terminal 200 transmit and receive radio signals to and from the wireless AP 300 and Wi-Fi P2P communication in which the first terminal 100 and the second terminal 200 transmit and receive radio signals to and from each other directly without the wireless AP 300. The first terminal 100 and the second terminal 200 may be implemented by a smart phone, a mobile communication terminal, a tablet computer, a notebook computer, a portable device, a digital camera, a digital audio player, a printer, and the like.

The wireless access point 300 is a device that relays connection between wired and wireless networks and the first terminal 100 and/or the second terminal 200. The wireless access point 300 performs the Wi-Fi communication with the first terminal 100 and the second terminal 200.

The first terminal 100 and the second terminal 200 require connection information constituted by a service set identifier (SSID), a security scheme, and a password of the wireless access point 300 in order to create the Wi-Fi connection with the wireless access point 300.

On the contrary, the first terminal 100 requires connection information constituted by a media access control (MAC) address, a security scheme, and a personal identification number (PIN) of the second terminal 200 in order to create the Wi-Fi P2P connection with the second terminal 200.

In the related art, an SSID, an MAC address, and a security scheme of an accessed terminal (device) are verified through a device discovery process for the Wi-Fi and/or Wi-Fi P2P connection and a password and a PIN are requested to a device owner, but in the present invention, the accessed device transfers connection information therewith to a peripheral terminal (device) through a management frame to ensure connection information of a device (accessed terminal) which the peripheral terminal will access in advance.

FIG. 2 illustrates a block configuration diagram of an apparatus for managing instant connection based on a wireless local area network according to an exemplary embodiment of the present invention.

As illustrated in FIG. 2, the apparatus for managing instant connection according to the present invention includes a user input unit 110, a display unit 120, a wireless communication unit 130, a connection information creating unit 140, a connection information extracting unit 150, a management frame creating unit 160, and a control unit 170.

The user input unit 110 receives data such as the password or the personal identification number (PIN) from a user. The user input unit 110 is implemented by a keypad, a touch pad, and a touch screen integrated with a display, and the like.

The display unit 120 displays a status and created data depending on an operation of the terminal. The display unit 120 may be implemented by a liquid crystal display (LCD), a flexible display, a light emitting diode (LED) display, a transparent display, a touch screen, a light emitting element, and the like.

The wireless communication unit 130 includes a Wi-Fi module which is a communication module for performing wireless communication. The wireless communication unit 130 performs Wi-Fi communication or Wi-Fi P2P communication with a wireless access point (AP) and/or other terminal positioned therearound (within a predetermined radius).

The connection information creating unit 140 includes a first connection information creating unit creating Wi-Fi connection information required for the Wi-Fi connection and a second connection information creating unit creating Wi-Fi P2P connection information required for the Wi-Fi P2P connection. Herein, the Wi-Fi connection information includes a service set identifier (SSID), a security scheme, and a password of the wireless access point and the Wi-Fi P2P connection information includes a media access control (MAC) address, a security scheme, and a PIN of the terminal. The security scheme may be any one of Wi-Fi protected setup (WPS), Wi-Fi protected access-pre-shared key (WPA-PSK), and Wi-Fi protected access II-pre-shared key (WPA2-PSK).

When the connection information extracting unit 150 receives the management frame through the wireless communication unit 130, the connection information extracting unit 150 extracts connection information by parsing the received management frame. The connection information extracting unit 150 includes a first connection information extracting unit extracting the Wi-Fi connection information included in the management frame and a second connection information extracting unit extracting the Wi-Fi P2P connection information from the management frame.

The management frame creating unit 160 prepares the management frame by using the connection information received from the connection information creating unit 140. The management frame is exchanged in order to establish initial communication among an IEEE 802.11 standard based terminal and the wireless AP 300 or terminals and used for discovery, authentication, and connection processes of the peripheral device. In the present invention, a terminal that desires access to another terminal transmits connection information therewith to the peripheral terminal through the management frame. That is, the management frame serves as an access invitation message for inviting the access of peripheral devices.

The control unit 170 transmits the management frame created by the management frame creating unit 160 to the peripheral devices through the wireless communication unit 130. When the control unit 170 receives the management frame through the wireless communication unit 130, the control unit 170 transfers the received management frame to the connection information extracting unit 150.

The control unit 170 visualizes a list of currently accessible wireless access points and/or terminals based on the connection information extracted through the connection information extracting unit 150 to output the visualized list to the display unit 120. The control unit 170 sets connection with the corresponding device by accessing the corresponding device by controlling the wireless communication unit 130 when any one item in the currently accessible device list is selected.

In the exemplary embodiment, it is described that a device selected by a user is accessed in the currently accessible device list, but the present invention is not limited thereto and a device to be accessed may be selected according to a predetermined rule. For example, the control unit 170 may control selecting a device having largest signal intensity in the currently accessible device list to access the selected device or access a device which is previously set to access at a current position in the currently accessible device list.

All or some of components of the instant connection managing apparatus are provided in the terminals 100 and 200 and the wireless AP 300.

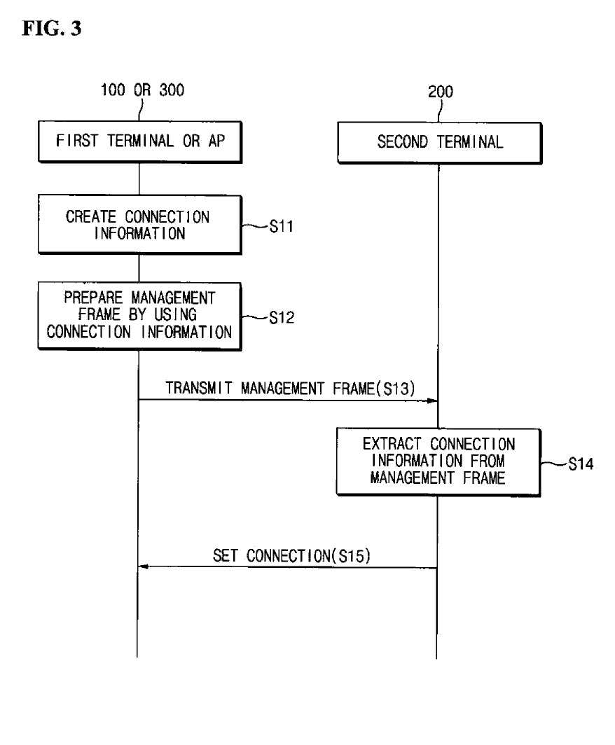

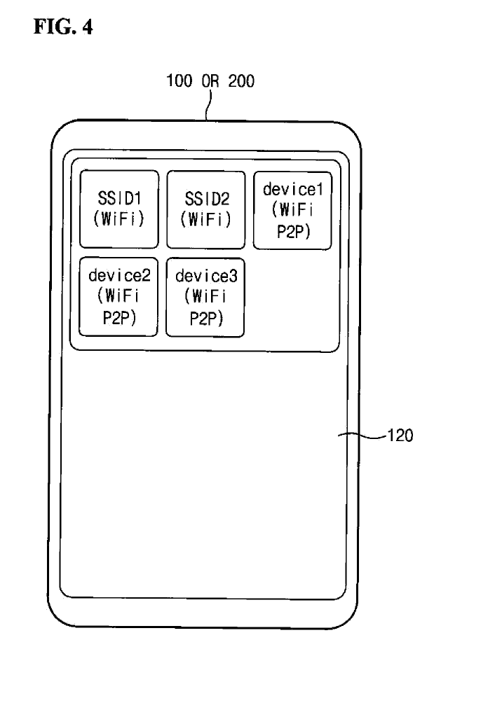

FIG. 3 is a flowchart illustrating a method for managing instant connection based on a wireless local area network according to an exemplary embodiment of the present invention. FIG. 4 is an exemplary diagram illustrating a display screen of a currently accessible device list of a terminal according to an exemplary embodiment of the present invention.

As illustrated in FIG. 3, the accessed terminal 100 or 300 creates connection information required for accessing the accessed terminal 100 or 300 (S11). In this case, the accessed terminal 100 or 300 creates the connection information by receiving a password and/or a PIN from a user as necessary. Herein, the connection information is Wi-Fi connection information for Wi-Fi connection and/or Wi-Fi P2P connection information for Wi-Fi P2P connection.

The accessed terminal 100 or 300 creates a management frame by using the created connection information (S12).

The accessed terminal 100 or 300 transmits the management frame to peripheral terminals 200 positioned within a predetermined radius through the wireless communication unit 130 (S13).

When the peripheral terminal 200 receives the management frame transmitted from the accessed terminal 100 or 300, the peripheral terminal 200 extracts the connection information included in the management frame by parsing the received management frame (S14). Herein, the peripheral terminal 200 visualizes and displays the currently accessible device list (effective connection information list) based on the extracted connection information as illustrated in FIG. 4. In other words, the display unit 120 may display the device list as a list of a text form or image and display the device list in a thumbnail form according to a control by the control unit 170.

The peripheral terminal 200 sets connection with the corresponding terminal 100 or 300 by accessing the corresponding terminal 100 or 300 by using the extracted connection information (S15). For example, the peripheral terminal 200 accesses the corresponding device when any one device (terminal) in the currently accessible device list displayed on a screen of the display unit 120 is selected by the user as illustrated in FIG. 4. In other words, the peripheral terminal 200 sets the Wi-Fi connection with the corresponding terminal when connection information selected by the user in the effective connection information is the Wi-Fi connection information and sets the Wi-Fi P2P connection with the corresponding terminal when the selected connection information is the Wi-Fi P2P connection information.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

What is claimed is:

1. A method for managing instant connection based on a wireless local area network, the method comprising:
creating, by an accessed terminal, connection information required for setting connection therewith;
creating, by the accessed terminal, a management frame by using the connection information;
transmitting, by the accessed terminal, the created management frame to a peripheral terminal;
receiving, by the peripheral terminal, the management frame and extracting connection information from the received management frame; and
setting, by the peripheral terminal, connection with the accessed terminal by accessing the accessed terminal by using the extracted connection information.

2. The method of claim 1, wherein the accessed terminal is a wireless access point or a mobile terminal.

3. The method of claim 1, wherein the connection information is Wi-Fi connection information constituted by a service set identifier (SSID), a security scheme, and a password of the wireless access point.

4. The method of claim 1, wherein the connection information is Wi-Fi P2P connection information constituted by a media access control (MAC) address, a security scheme, and a personal identification number of the terminal.

5. The method of claim 3, wherein the security scheme is any one of Wi-Fi protected setup (WPS), Wi-Fi protected access-pre-shared key (WPA-PSK), and Wi-Fi protected access II-pre-shared key (WPA2-PSK).

6. The method of claim 4, wherein the security scheme is any one of Wi-Fi protected setup (WPS), Wi-Fi protected access-pre-shared key (WPA-PSK), and Wi-Fi protected access II-pre-shared key (WPA2-PSK).

7. The method of claim 1, wherein in the setting of connection, Wi-Fi connection or Wi-Fi peer to peer (P2P) connection is formed by using the extracted connection information.

8. An apparatus for managing instant connection based on a wireless local area network, the apparatus comprising:
a wireless communication unit performing wireless communication on the wireless local area network;
a connection information creating unit creating connection information for accessing another terminal positioned on the wireless local area network;
a management frame creating unit creating a management frame by using the connection information received from the connection information creating unit;
a connection information extracting unit extracting the connection information from the received management frame by parsing the management frame received through the wireless communication unit; and
a control unit transmitting the management frame created by the management frame creating unit to a peripheral terminal through the wireless communication unit and performing connection setting by accessing the corresponding terminal by using the connection information extracted by the connection information extracting unit.

9. The apparatus of claim 8, further comprising:
a user input unit receiving a password and a personal identification number from a user,
wherein the connection information creating unit creates the connection information by using the password and the personal identification number.

10. The apparatus of claim 8, wherein the control unit visualizes and displays effective connection information based on the connection information extracted by the connection information extracting unit.

11. The apparatus of claim 10, wherein when any one connection information in the displayed effective connection information is selected, the control unit sets Wi-Fi connection or Wi-H peer to peer (P2P) connection with the corresponding terminal by using the selected connection information.

12. The apparatus of claim 10, wherein the control unit sets the Wi-Fi connection or the Wi-Fi P2P connection by accessing a terminal having largest signal intensity among terminals corresponding to the effective connection information.
